(19) United States
(12) Patent Application Publication
(10) Pub. No.: US 2021/0233471 A1
(43) Pub. Date: Jul. 29, 2021

(54) APPARATUS AND METHOD FOR CONTROL AND DISPLAY APPARATUS

(71) Applicant: SHARP KABUSHIKI KAISHA, Osaka (JP)

(72) Inventors: YOHICHI TAKAZANE, Osaka (JP); KEISUKE HAMAJIMA, Osaka (JP)

(21) Appl. No.: 17/151,414

(22) Filed: Jan. 18, 2021

(30) Foreign Application Priority Data
Jan. 23, 2020 (JP) 2020-009378

(51) Int. Cl. G09G 3/3233

(52) U.S. Cl. CPC G09G 3/3233; G09G 2320/0626; G09G 2330/025

(57) ABSTRACT

A control apparatus that controls display of a self-luminous display panel, the control apparatus comprises a current supply unit configured to selectively supply a first current and a second current smaller than the first current to the self-luminous display panel; and an abnormality detection unit configured, when the second current is supplied, to determine that the display of the self-luminous display panel is abnormal when the second current is larger than a second threshold smaller than a first threshold used as a threshold of the first current.

### BACKGROUND

### 1. Field

An aspect of the present disclosure relates to a control apparatus that controls display of a self-luminous display panel.

### 2. Description of the Related Art

A known example of self-luminous display panels in the related art is an organic light-emitting diode (OLED) panel using OLED devices.

In OLED panels, generally, a large amount of current flows through the OLED devices when an abnormality occurs. This can cause the OLED panels to generate heat, and mobile terminals using the OLED panels as display panels may become hot. Accordingly, for example, the technique disclosed in Japanese Unexamined Patent Application Publication (Translation of PCT Application) No. 2012-527074 determines whether an abnormality has occurred in the OLED panel from the amount of current supplied to the OLED panel, and when an abnormality has occurred, stops the supply of current to the OLED panel.

OLED panels are so-called scan-type display panels that display images by scanning lines from the top to the bottom of the display screen. In such scan-type display panels, if a gate circuit is damaged, lines following the lines corresponding to the damaged gate circuit, that is, lines on the scan end side, may not be driven correctly.

### SUMMARY

In such a case, if an abnormality occurs near a screen upper end 11a of the OLED panel 11, substantially the entire surface of the OLED panel 11 becomes an abnormal light-emitting area 11c, as shown in FIG. 2A. If an abnormality occurs near a screen lower end 11b of the OLED panel 11, a very narrow area of the OLED panel 11 adjacent to the screen lower end 11b becomes an abnormal light-emitting area 11c, as shown in FIG. 2B.

In detecting an abnormality in a conventional OLED panel, the threshold of a current supplied to the OLED panel is set to a value that slightly exceeds a current value required to display the entire OLED panel in white (for example, 1 A). For this reason, when substantially the entire surface of the OLED panel 11 becomes the abnormal light-emitting area 11c, as shown in FIG. 2A, the value of the current supplied to the OLED panel 11 exceeds the threshold, allowing detecting the abnormality of the OLED panel 11 without any problem. However, when a very narrow area of the OLED panel 11 becomes the abnormal light-emitting area 11c, as shown in FIG. 2B, the value of the current supplied to the OLED panel 11 is obviously small, and even. if the current value is large in some degree, the value may not exceed the threshold. Accordingly, even if a very small area of the OLED panel 11 becomes the abnormal light-emitting area 11c, the abnormality is determined to be within a normal range and is not determined to be abnormal.

Thus, the conventional abnormality detection method for the OLED panel 11 may not properly detect such an abnormality that a very small area becomes an abnormal light-emitting area.

According to an aspect of the present disclosure, there is provided a control apparatus capable of appropriately detecting an abnormality of a small area (narrow area) of a self luminous display panel.

A control apparatus according to an aspect of the present disclosure is a control apparatus that controls display of a self-luminous display panel. The control apparatus includes a current supply unit configured to selectively supply a first current and a second current smaller than the first current to the self-luminous display panel and an abnormality detection unit configured, when the second current is supplied, to determine that the display of the self-luminous display panel is abnormal when the second current is larger than a second threshold smaller than a first threshold used as a threshold of the first current.

A method of control according another aspect of the present disclosure is a method for controlling display of a self-luminous display panel. The method includes selectively supplying a first current and a second current smaller than the first current to the self-luminous display panel and determining, when the second current is supplied, that the display of the self-luminous display panel is abnormal when the second current is larger than a second threshold smaller than a first threshold used as a threshold of the first current.

### BRIEF DESCRIPTION OF THE DRAWINGS

FIG. 1 is a block diagram illustrating, in outline, the configuration of a display apparatus according to a first embodiment of the present disclosure;

FIG. 2A is a diagram for illustrating the occurrence of an abnormality in an OLED panel;

FIG. 2B is a diagram for illustrating the occurrence of an abnormality in an OLED panel;

FIG. 3 is a flowchart showing the processing procedure of abnormality detection performed by the display apparatus shown in FIG. 1;

FIG. 4 is a flowchart showing the processing procedure of the OFF sequence in the flowchart of FIG. 3;

FIG. 5A is a block diagrams illustrating, in outline, the configuration of a display apparatus according to a second embodiment of the present disclosure;

FIG. 5B is a block diagrams illustrating, in outline, the configuration of the display apparatus according to the second embodiment of the present disclosure;

FIG. 6 is a flowchart showing the processing procedure of abnormality detection performed by the display apparatus shown in FIGS. 5A and 5B;

FIG. 7A is a block diagrams illustrating, in outline, the configuration of a display apparatus according to a third embodiment of the present disclosure;

FIG. 7B is a block diagrams illustrating, in outline, the configuration of the display apparatus according to the third embodiment of the present disclosure; and

FIG. 8 is a flowchart showing the processing procedure of abnormality detection performed by the display apparatus shown in FIGS. 7A and 7B.

### DESCRIPTION OF THE EMBODIMENTS

### First Embodiment

An embodiment of the present disclosure will be described in detail hereinbelow. In this embodiment, an organic light emitting diode (OLED) panel in which a plurality of organic light emitting devices are arranged in a matrix form will be described as an example of the self-luminous display panel.

### Outline of Display Apparatus

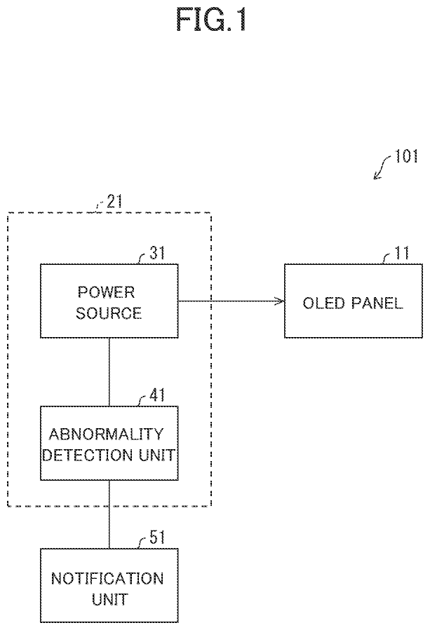

FIG. 1 is a block diagram illustrating, in outline, the configuration of a display apparatus 101 according to this embodiment.

As shown in FIG. 1, the display apparatus 101 includes an OLED panel 11, a control apparatus 21 that controls display of the OLED panel 11, and a notification unit 51 that reports detection of an abnormality of the OLED panel 11.

The control apparatus 21 includes a power source 31 serving as a current supply unit that supplies a light emitting current to the OLED panel 11 and an abnormality detection unit 41 that detect an abnormality of the OLED panel 11. The abnormality of the OLED panel 11 refers to a state in which the OLED panel 11 is normally driven because of a damage in a gate circuit which is a drive circuit, so that the OLED panel 11 is supplied with an excess current and abnormally emits light.

The power source 31 is a power management integrated circuit (PMIC) that selectively supplies light emitting currents with two different values to the OLED panel 11. Specifically, the power source 31 switches between a first current to be supplied to the OLED panel 11 at normal display and a second current to be supplied to the OLED panel 11 at abnormality detection (specifically, at black screen display) and supplies the current to the OLED panel 11. The value of the second current is set smaller than the value of the first current. This is for the purpose of ensuring that an abnormality in the OLED panel 11 is detected by the abnormality detection unit 41.

Assuming that the threshold (a first threshold) of the light emission current that is supplied to the OLED panel 11 at normal display (the first current) is 1 A, the threshold (a second threshold) of the light emission current that is supplied to the OLED panel 11 at abnormality detection (the second current) is set at 1 mA. The thresholds are merely examples and may be any values. For example, the first threshold may be set to the value of a current supplied when the entire surface of the OLED panel 11 is displayed at the highest luminance (full white display), and the second threshold may be set to the value of a current that is supplied when the entire surface of the OLED panel 11 is displayed at the lowest luminance (full black display). Thus, setting the second threshold reduces the possibility that the second current exceeds the second threshold when the OLED panel 11 has no abnormality at full black display. Thus, when the second current exceeds the second threshold, the abnormality of the OLED panel 11 can easily be detected.

The abnormality detection unit 41 detects an abnormality of the OLED panel 11 when the first current supplied by the power source 31 exceeds the first threshold at normal display. When the abnormality is detected, the control apparatus 21 determines that an excess current flows in the terminal equipped with the OLED panel 11 and shuts down the terminal to reduce problems caused by the excess current flowing in the terminal, such as the breakage and the heat generation of the circuit.

In abnormality detection, the abnormality detection unit 41 detects an abnormality of the OLED panel 11 from a voltage drop that occurs when the second current supplied by the power source 31 exceeds the second threshold. In abnormality detection, the abnormality detection unit 41 may detect an abnormality of the OLED panel 11 from the fact that the second current supplied by the power source 31 exceeds the second threshold.

Although an abnormality of the OLED panel 11 may be detected by the abnormality detection unit 41, as described above, the abnormality may be detected by the power source 31. In this case, there is no need to provide the abnormality detection unit 41, thus simplifying the circuit configuration of the control apparatus 21.

When an abnormality of the OLED panel 11 is detected by the abnormality detection unit 41, the notification unit 51 notifies the user that the OLED panel 11 has an abnormality. Examples of a method of notification include a method using the speaker or the display screen of a mobile terminal (a smartphone or the like) including the display apparatus 101 and a method of vibrating the mobile terminal.

### OLED Panel

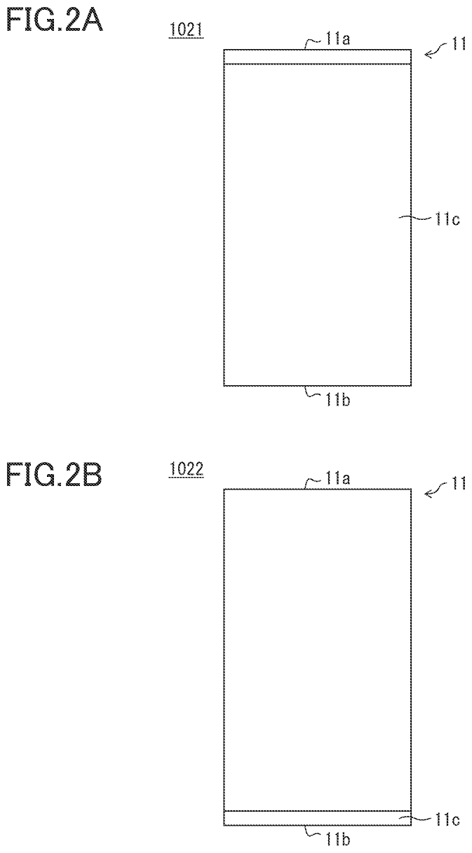

FIGS. 2A and 2B are diagrams for illustrating the occurrence of an abnormality in the OLED panel 11.

As illustrated in FIGS. 2A and 2B, the OLED panel 11 is a so-called scan-type display panel in which an image is written while being scanned from the screen upper end 11a to the screen lower end 11b to display a desired image.

If a gate circuit that scans the OLED panel 11 is damaged, lines adjacent to the screen lower end 11b from the scanned line may not be correctly driven. In such a case, a large amount of light emission current is supplied to the OLED panel 11 to cause the OLED panel 11 to emit light abnormally.

When the first current supplied to the OLED panel 11 at normal display exceeds the first threshold to cause the OLED panel 11 to emit light abnormally, substantially the entire surface of the OLED panel 11 becomes the abnormal light-emitting area 11c, as shown in FIG. 2A. In contrast, when the abnormal light-emitting area 11c of the OLED panel 11 is very narrow, as shown in FIG. 2B, a current exceeding the first threshold at normal display does not flow. An abnormality of such a narrow area of the OLED panel 11 may not be detected.

For that reason, when a very small area of the OLED panel 11 is the abnormal light-emitting area 11c, as shown in FIG. 2B, the threshold for abnormal current detection is set smaller than the first threshold in a small-current display mode in which much current does not flow across the entire OLED panel 11 to enable abnormality detection. In other words, the power source 31 the supply current from the first current to the second current (smaller than the first current) for abnormality detection and supplies the second current to the OLED panel 11, also the threshold is switched from the first threshold to the second threshold, and the abnormality detection unit 41 detects that an abnormality has occurred in the OLED panel 11 from a voltage drop caused when the second current exceeds the second threshold. The abnormality of the OLED panel 11 may be detected not only when the voltage has dropped but also when the second current has exceeded the second threshold.

The abnormality detection is performed at the time the user does not aware that abnormality detection is being performed, such as when the user turns on or off the display apparatus 101. The following is an example in which abnormality detection is performed when the display apparatus 101 is turned off, that is, at the time of an OFF sequence.

### Abnormality Detection

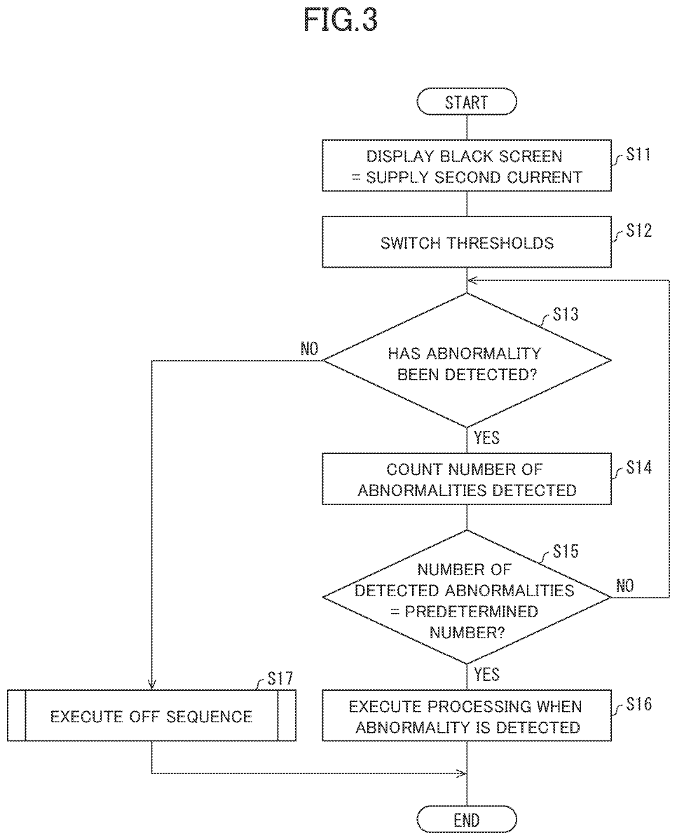

FIG. 3 is a flowchart showing the processing procedure of abnormality detection. This is an example in which the display apparatus 101 is used as the display apparatus of a mobile terminal.

When the power source of the mobile terminal including the display apparatus 101 is turned off by the user, the display apparatus 101 first displays the screen in black (=supplies the second current) (step S11). Here, the OLED panel 11 displays the entire screen in black in the state of normal display. In other words, the current is switched from the first current at normal display to the second current for full black display, and the second current is supplied to the OLED panel 11 by the power source 31.

Next, the thresholds are switched (step S12). Here, the first threshold is switched to the second threshold.

Next, abnormality detection is performed (step S13). Here, the abnormality detection unit 41 determines whether the voltage has dropped when the second current supplied to the OLED panel 11 has exceeded the second threshold. If it is determined that the voltage has dropped, then the processing goes to step S14 since the abnormality of the OLED panel 11 has been detected, and the number of abnormalities detected is counted. The abnormality of the OLED panel 11 may detected not only when the voltage has dropped but also when the second current has exceeded the second threshold.

Next, in step S14, it is determined whether the number of abnormalities detected has reached a predetermined number (step S15). The predetermined number is assumed to be a number that allows determining that abnormality has certainly occurred in the OLED panel 11. In this embodiment, the predetermined number is, but is not limited to, three.

Accordingly, if at step S15 the number of abnormalities detected reaches the predetermined number (Yes), it is determined that an abnormality has occurred in the OLED panel 11, and processing when an abnormality has been detected is executed (step S16).

In contrast, if at step S15 the number of abnormalities detected has not reached the predetermined number (No), then the processing goes to step S13, and abnormality detection is performed.

The processing when an abnormality has been detected at step S16 is to notify the user that an abnormality has occurred in the OLED panel 11 with the notification unit 51 of the display apparatus 101. Besides, the power source of the display apparatus 101 is turned off to stop the supply of current to the OLED panel 11, the is, so-called mobile terminal shut down processing is performed. This stops continuing the abnormal light emission of the OLED panel 11, avoiding the OLED panel 11 from becoming hot with abnormal light emission. Moreover, since the user is notified of the abnormality of the OLED panel 11, the user is not confused even if the mobile terminal is suddenly shut down. Alternatively, the power source may be kept ready for turning on with the display kept off so that the data in the mobile terminal can be taken out after an abnormality is detected.

In contrast, if at step S13 it is determined that no abnormality is detected (No), a normal OFF sequence is executed (step S17) because an abnormality of the OLED panel 11 has not been detected.

### OFF Sequence

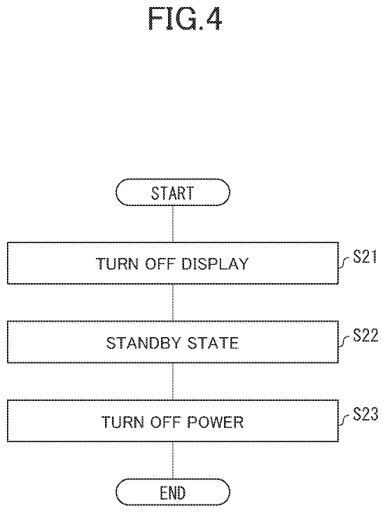

FIG. 4 is a flowchart showing the processing procedure of the OFF sequence.

Since in this embodiment the OFF sequence is executed after the processing of abnormality detection is performed, the operation of turning off the mobile terminal has already been executed by the user.

Therefore, when the OFF sequence is executed, the display apparatus 101 is turned off at step S21. The OFF state of the display apparatus 101 is a state in which scanning of the OLED panel 11 is stopped.

Then, the processing goes to step S22 to bring the display apparatus 101 into standby state. The standby state of the display apparatus 101 is a state in which the display apparatus 101 returns to a driven state (scan state) when a signal is input from the outside. Accordingly, when at step S22 a predetermined time passes in the standby state, the processing goes to step S23, and the power source is turned OFF. The power source in this case includes various power sources of the display apparatus 101 including the power source 31 that supplies a light emission current to the OLED panel 11.

Although in this embodiment the abnormality detection of the OLED panel 11 is performed immediately before the execution of the OFF sequence, the abnormality detection may be performed immediately before the ON sequence. In this case, the abnormality detection of the OLED panel 11 is triggered by the user turning on the main power source of the mobile terminal including the display apparatus 101.

### Advantageous Effects

The display apparatus 101 with the above configuration can detect an abnormality of the OLED panel 11 even if an increase in the supplied first current is so small that is undetectable using the first threshold or even if the voltage drop is undetectable by supplying the second current smaller than the first current and by switching the first threshold to the second threshold less than the first threshold. In particular, when a narrow area of the OLED panel 11 adjacent to the screen lower end 11b is the abnormal light-emitting area 11c, as shown in FIG. 2B, the current increase due to the abnormality is not detected using the first threshold because it is small. For this reason, the current increase is determined to be within a normal range and is not detected as an abnormality. However, using the second current smaller than the first current and using the second threshold smaller than the first threshold allows detecting the current increase, even if it is small, or the voltage drop, allowing detecting the abnormality of the OLED panel 11. In other words, even if a narrow area of the OLED panel 11 adjacent to the screen lower end 11b is the abnormal light-emitting area 11c, as shown in FIG. 2B, abnormality can be detected. Thus, the heat generation of the OLED panel 11 due to an increase in light emission current can be reduced by detecting abnormality.

Although this embodiment illustrates an example in which the first current and the second current are selectively supplied to the OLED panel 11 by one power source 31, second and third embodiments illustrate examples in which the first current and the second current are supplied by different power sources.

### Second Embodiment

Another embodiment of the present disclosure will be described hereinbelow. Components having the same functions as those of the components described in the above embodiment are given the same reference signs, and descriptions thereof will not be repeated for the convenience of description.

### Outline of Display Apparatus

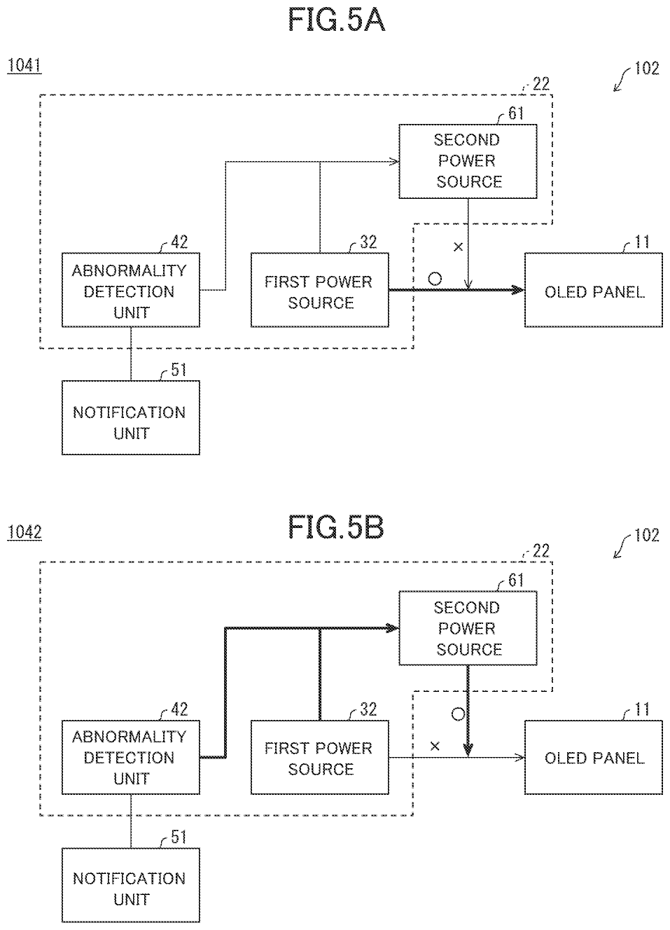

FIGS. 5A and 5B are block diagrams illustrating, in outline, the configuration of a display apparatus 102 according to this embodiment.

As shown in FIGS. 5A and 5B, the display apparatus 102 includes an OLED panel 11, a control apparatus 22 that controls display of the OLED panel 11, and a notification unit 51 that notifies the user of an abnormality of the OLED panel 11.

The control apparatus 22 includes a first power source 32 serving as a current supply unit that supplies a light emission current (a first current) to the OLED panel 11 and an abnormality detection unit 42 that detects an abnormality of the OLED panel 11. The control apparatus 22 further includes a second power source 61 serving as a current supply unit that supplies a current (a second current) in detecting an abnormality of the OLED panel 11 (specifically, at black screen display).

The first power source 32 is a PMIC, as is the power source 31 of the first embodiment, and supplies only the first current to be supplied to the OLED panel 11 at normal display to the OLED panel 11. The second current to be supplied to the OLED panel 11 at abnormality detection is supplied by the second power source 61 different from the first power source 32.

Also in this embodiment, the threshold (a first threshold) of the light emission current that is supplied to the OLED panel 11 at normal display (the first current) is 1 A, as in the first embodiment, and the threshold (a second threshold) of the light emission current that is supplied to the OLED panel 11 at abnormality detection (the second current) is set at 1 mA. The thresholds are merely examples and may be any values.

The abnormality detection unit 42 detects an abnormality of the OLED panel 11 when the first current supplied by the first power source 32 exceeds the first threshold at normal display. When the abnormality is detected, the control apparatus 22 determines that an excess current flows in the terminal equipped with the OLED panel 11 and shuts down the terminal to reduce problems caused by the excess current flowing in the terminal, such as the breakage and the heat generation of the circuit.

In abnormality detection, the abnormality detection unit 42 detects an abnormality of the OLED panel 11 from a voltage drop that occurs when the second current supplied by the second power source 61 exceeds the second threshold. In abnormality detection, the abnormality detection unit 42 may detect an abnormality of the OLED panel 11 from the fact that the second current supplied by the second power source 61 exceeds the second threshold.

Although an abnormality of the OLED panel 11 may be detected by the abnormality detection unit 42, as described above, the abnormality may be detected by each of the first power source 32 and the second power source 61. In this case, there is no need to provide the abnormality detection unit 42, thus simplifying the circuit configuration of the control apparatus 22.

When an abnormality of the OLED panel 11 is detected the detection unit 42, the notification unit 51 notifies the user that the OLED panel 11 has an abnormality. Examples of a method of notification include a method using the speaker or the display screen of a mobile terminal (a smartphone or the like) including the display apparatus 102 and a method of vibrating the mobile terminal.

### Abnormality Detection

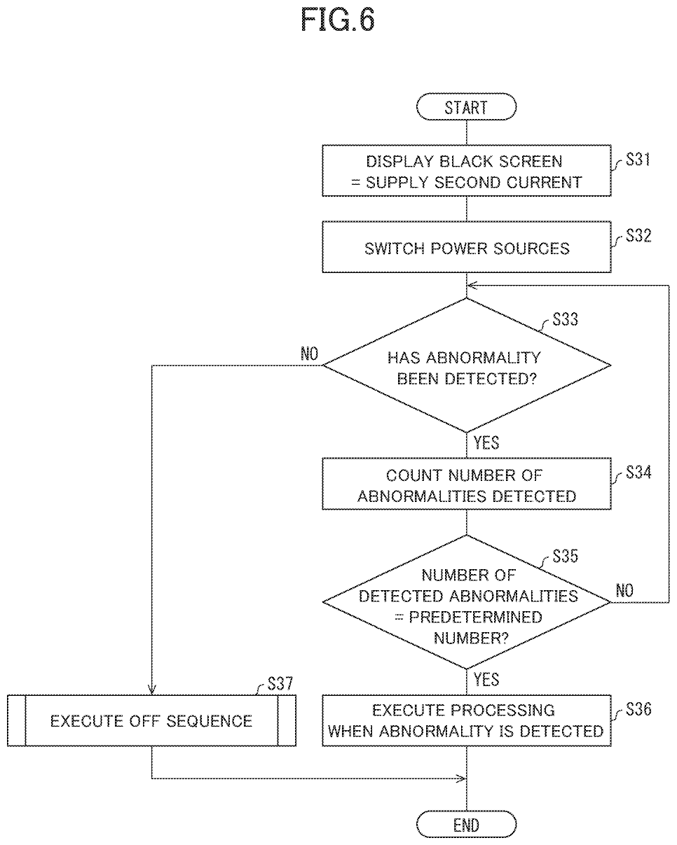

FIG. 6 is a flowchart showing the processing procedure of abnormality detection.

The flowchart of FIG. 6 is the same as the flowchart of the first embodiment in FIG. 3 except step S32. In other words, step S31 is the same as step S11 in FIG. 3, and steps S33 to S37 are the same as steps S13 to S17 in FIG. 3, respectively.

In step S32, the power sources are switched. Here, the power sources are switched from the first power source 32 that supplies the first current at normal display to the second power source 61 that supplies the second current in abnormality detection (at black screen display for abnormality detection) to supply the second current from the second power source 61 to the OLED panel 11.

### Advantageous Effects

The display apparatus 102 with the above configuration provides the same advantageous effects as those of the first embodiment and also allows using lower-priced power sources because using different power sources for two kinds of current than that of a case in which two kinds of current are switched by one power source. In other words, although a power source that switches two kinds of current is expensive, a power source that supplies only one kind of current is inexpensive. Thus, the display apparatus 102 itself can be produced at low cost.

### Third Embodiment

Another embodiment of the present disclosure will be described hereinbelow. Components having the same functions as those of the components described in the above embodiment are given the same reference signs, and descriptions thereof will not be repeated for the convenience of description.

### Outline of Display Apparatus

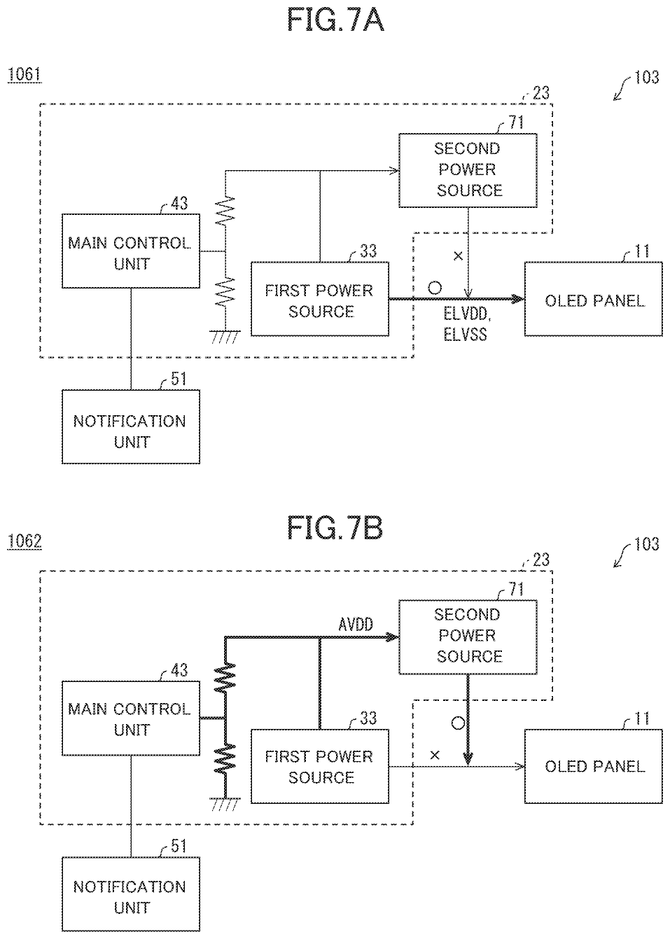

FIGS. 7A and 7B are block diagrams illustrating, in outline, the configuration of a display apparatus 103 according to this embodiment.

As shown in FIGS. 7A and 7B, the display apparatus 103 includes an OLED panel 11, a control apparatus 23 that controls display of the OLED panel 11, and a notification unit 51 that reports detection of an abnormality of the OLED panel 11.

The control apparatus 23 includes a first power source 33 serving as a current supply unit that supplies a light emission current (a first current) to the OLED panel 11 and a second power source 71 serving as a current supply unit that supplies a current (a second current) in displaying a black screen to detect abnormality (at driving with low current consumption). The control apparatus 23 further includes a main control unit 43 that controls the first power source 33 and the second power source 71.

The first power source 33 is a PMIC, as is the power source 31 of the first embodiment, and supplies a first current (ELVDD or ELVSS) to the OLED panel 11 at normal display. In displaying a black screen for abnormality detection (at driving with low current consumption), the second current is supplied to the OLED panel 11 from the second power source 71 different from the first power source 32.

In this embodiment, the driver of the OLED panel 11 is used as the second power source 71. The second power source 71 supplies AVDD supplied from the main control unit 43 to the driver to the OLED panel 11 as the second current (a current supplied in displaying a black screen to detect abnormality [at driving with low current consumption]).

In other words, the display apparatus 103 according to this embodiment has an energy saving function for displaying only necessary information (for example, clock display) on the OLED panel 11 at low power consumption and detects an abnormality of the OLED panel 11 using this energy saving function. In other words, with the energy saving function, supply of ELVDD or ELVSS from the first power source 33 is stopped, and only AVDD is supplied from the second power source 71.

The main control unit 43 is a host IC that controls the display of the OLED panel 11 and detects an abnormality of the OLED panel 11 when the first current supplied by the first power source 33 exceeds the first threshold. When detecting the abnormality, the main control unit 43 determines that an excess current is flowing in the terminal equipped with the OLED panel 11 and shuts down the terminal to reduce problems caused by the excess current, for example, the breakage and the heat generation of the circuit.

The main control unit detects an abnormality of the OLED panel 11 from a voltage drop caused when the second current supplied by the second power source 71 exceeds the second threshold in displaying a black screen to detect abnormality (at driving with low current consumption). In other words, when a black screen is displayed to detect abnormality (at driving with low current consumption), the main control unit 43 detects an abnormality of the OLED panel 11 by supplying only AVDD to the OLED panel 11 using the energy saving function to constantly monitor the voltage drop of the second power source 71.

When an abnormality of the OLED panel 11 is detected the main control unit 43, the notification unit 51 notifies the user that the OLED panel 11 has an abnormality. Examples of a method of notification include a method using the speaker or the display screen of a mobile terminal (a smartphone or the like) including the display apparatus 101 and a method of vibrating the mobile terminal.

### Abnormality Detection

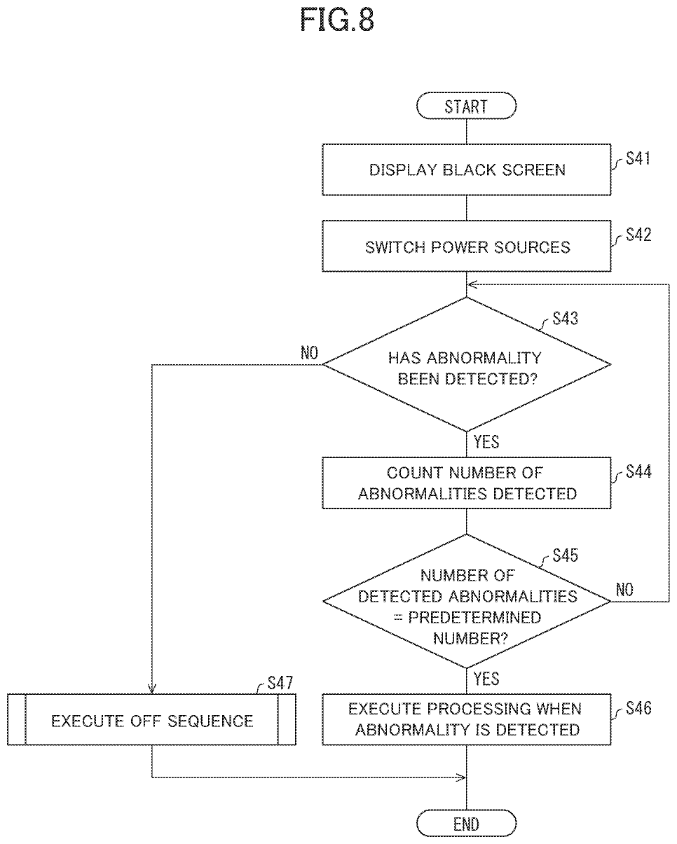

FIG. 8 is a flowchart showing the processing procedure of abnormality detection.

The flowchart of FIG. 8 is the same as the flowchart of the first embodiment in FIG. 3 except step S42. In other words, step S41 is the same as step S11 in FIG. 3, and steps S43 to S47 are the same as steps S13 to S17 in FIG. 3, respectively.

In step S42, the power sources are switched. Here, the power sources are switched from the first power source 33 that supplies the first current at normal display to the second power source 71 that supplies the second current in displaying a black screen for abnormality detection (at driving with low current consumption) to supply the second current from the second power source 71 to the OLED panel 11.

### Advantageous Effects

The display apparatus 103 with the above configuration provides the same advantageous effects as those of the first embodiment. Furthermore, the display apparatus 103 does not need to have an additional circuit for abnormality detection because the display apparatus 103 uses a driver used in an existing energy saving function as the second power source 71 serving as a supply source of the second current used in displaying a black screen for abnormality detection.

In the first to third embodiments, the OLED panel has been described as an example of the self-luminous display panel. However, the present disclosure is not limited to the OLED panel and may also be applied to another self-luminous display panel, such as a quantum dot light emitting diode (OLED) panel.

### Implementation Examples Using Software

The control block (in particular, the abnormality detection unit 41) of the control apparatus 21 of the display apparatus 101 may be implemented by a logic circuit (hardware) formed in an integrated circuit (an IC chip) or the like or by software.

In the latter case, the control apparatus 21 includes a computer that executes instructions of a program, which is software for implementing various functions. The composer includes, for example, at least one processor (a control apparatus) and at least one computer-readable recording medium storing the program. In the computer, the processor reads the program from the recording medium and executes the program. An example of the processor is a central processing unit (CPU). Examples of the recording medium include “a non-transitory tangible medium”, such as a read-only memory (ROM), a tape, a disk, a card, a semiconductor memory, and a programmable logic circuit. The computer may further include a random access memory (RAM) in which the program is expanded. The program may be supplied to one computer via any transmission medium (a communication network or a broadcast wave) capable of transmitting the program. In one embodiment of the present disclosure, the program may be in the form of a data signal embodied by electronic transmission and embedded in a carrier wave.

### Summary of Embodiments

A control apparatus according to a first aspect of the present disclosure is a control apparatus (21) that controls the display of a self-luminous display panel (an OLED panel 11). The control apparatus includes a current supply unit configured to selectively supply a first current and a second current smaller than the first current to the self-luminous display panel (OLED panel 11) and an abnormality detection unit (an abnormality detection unit 41) configured, when the second current is supplied, to determine that the display of the self-luminous display panel (OLED panel 11) is abnormal when the second current is larger than a second threshold smaller than a first threshold used as a threshold of the first current.

The above configuration allows detecting even an undetectable voltage drop due to a small increase in the supplied first current by supplying the second current smaller than the first current and by using the second threshold less than the first threshold. In particular, when a large current like the first current is supplied, an abnormality in display of a narrow area of the self-luminous display panel adjacent to the trailing end in the scanning direction may be determined to be within a normal range because its increase in current is small and may not be detected as an abnormality. However, supplying the second current smaller than the first current to the self-luminous display panel makes it easy to detect a voltage drop even if the current increase is small because the second threshold is smaller than the first threshold for the first current, allowing detecting an abnormality in a narrow area of the self-luminous display panel.

In a second aspect of the present disclosure, the control apparatus of the first aspect may be configured such that the current supply unit is a power source (31) that selectively supplies at least the first current and the second current.

The above configuration needs only one power source for two kinds of current (a first current and a second current), simplifying the configuration of the control apparatus. This can reduce the size of the control apparatus, and as a result, can reduce the size of a display apparatus including the control apparatus and the size of a mobile terminal including the display apparatus.

In a third aspect of the present disclosure, the control apparatus of the second aspect may be configured such the current supply unit includes at least a first power source (32 or 33) that supplies the first current and a second power source (61 or 71) that supplies the second current.

The above configuration uses different power sources for two kinds of current, allowing using lower-priced sower sources than that of a case in which two kinds of current are switched by one power source. In other words, although a power source that switches two kinds of current is expensive, a power source that supplies only one kind of current is inexpensive.

In a fourth aspect of the present disclosure, the control apparatus of the third aspect may be configured such that, the first power source (33) supplies the first current for use in normal light emission of the self-luminous display panel (OLED panel 11) and the second power source (71) supplies the second current for use in writing display data on the self-luminous display panel (OLED panel 11).

The above configuration does not need to have an additional circuit for abnormality detection because an existing power source (a driver) that supplies the second current for use in writing display data on the self-luminous display panel is used as the second power source serving as a second-current supply source for use in displaying a black screen for abnormality detection.

In a fifth aspect of the present disclosure, the control apparatus of any one of the first to fourth aspects may be configured such that the first threshold is a value of a current supplied when the entire surface of the self-luminous display panel (OLED panel 11) is displayed at highest luminance (all white) and that the second threshold is a value of a current supplied when the entire surface of the self-luminous display panel (OLED panel 11) is displayed at lowest luminance (all black).

With the above configuration, even if an increase in the second current supplied to the self-luminous display panel in displaying a black screen for abnormality detection is small, an abnormality of the self-luminous display panel can be accurately detected because the second threshold is the value of a current supplied when the entire surface is displayed at the lowest luminance (all black).

In a sixth aspect of the present disclosure, the control apparatus of any one of the first to fifth aspects may be configured such that, upon receiving an instruction to turn on or off the self-luminous display panel (OLED panel 11), the abnormality detection unit (41) performs abnormality detection on the self-luminous display panel (OLED panel 11) using the second current with the self-luminous display panel (OLED panel 11) displayed at the lowest luminance (all black).

With the above configuration, the abnormality detection of the self-luminous display panel is performed when an instruction to turn on the self-luminous display panel (power source ON) or an instruction to turn off the self-luminous display panel (power source OFF) is received, allowing abnormality detection without the user being aware of it.

In a seventh aspect of the present disclosure, the control apparatus of any one of the first to sixth aspects may further include a notification unit (51) configured, when an abnormality is detected by the abnormality detection unit (41), reports that the abnormality is detected.

The above configuration allows the user to be notified that an abnormality of the self-luminous display panel is detected. Thus, even if processing involved with the abnormality detected in the self-luminous display panel is performed, for example, the mobile terminal is suddenly shut down, the user may not become confused.

A method of control according to an eighth aspect of the present disclosure is a method for controlling display of a self-luminous display panel (OLED panel 11). The method includes selectively supplying a first current and a second current smaller than the first current to the self-luminous display panel (OLED panel 11) and determining, when the second current is supplied, that the display of the self-luminous display panel (OLED panel 11) is abnormal when the second current is larger than a second threshold smaller than a first threshold used as a threshold of the first current.

The method allows detecting even an undetectable voltage drop due to a small increase in the supplied first current by supplying the second current smaller than the first current and by using the second threshold less than the first threshold for use as the threshold of the first current. In particular, when a large current like the first current is supplied, an abnormality in display of a narrow area of the self-luminous display panel adjacent to the trailing end in the scanning direction may be determined to be within a normal range because its increase in current is mall and may not be detected as an abnormality. However, supplying the second current smaller than the first current to the self-luminous display panel makes it easy to detect a voltage drop even if the current increase is small because the second threshold is smaller than the first threshold for the first current, allowing detecting an abnormality in a narrow area of the self-luminous display panel.

A display apparatus according to a ninth aspect of the present disclosure includes a self-luminous display panel (OLED panel 11) and a control apparatus (21, 22, or 23) configured to control the display of the self-luminous display panel (OLED panel 11). The control apparatus (21, 22, or 23) may be the control apparatus according to any one of the first to seventh aspects.

The control apparatuses according to the aspects of the present disclosure may be implemented by a computer. In this case, a control program for the control apparatuses causing the control apparatuses to be implemented by the computer by operating the computer as the components (software elements) of the control apparatuses and a computer-readable recording medium storing the program are also within an aspect of the present disclosure.

It is to be understood that the present disclosure is not limited to the above embodiments and various modifications may be made within the scope of the appended claims and that embodiments obtained by combining the technical devices disclosed in the different embodiments are also included in the technical scope of the present disclosure. It is also to be understood that new technical features can be formed by combining the technical devices disclosed in the above embodiments.

While there have been described what are at present considered to be certain embodiments of the invention, it will be understood that various modifications may be made thereto, and it is intended that the appended claims cover all such modifications as fall within the true spirit and scope of the invention.

The present disclosure contains subject matter related to that disclosed in Japanese Priority Patent Application JP 2020-009378 filed in the Japan Patent Office on Jan. 23, 2020, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A control apparatus that controls display of a self-luminous display panel, the control apparatus comprising:
a current supply unit configured to selectively supply a first current and a second current smaller than the first current to the self-luminous display panel; and
an abnormality detection unit configured, when the second current is supplied, to determine that the display of the self-luminous display panel is abnormal when the second current is larder than a second threshold smaller than a first threshold. used as a threshold of the first current.

2. The control apparatus according to claim 1, wherein the current supply unit is a power source that selectively supplies at least the first current and the second current.

3. The control apparatus according to claim 1, wherein the current supply unit includes:
at least a first power source that supplies the first current; and
a second power source that supplies the second current.

4. The control apparatus according to claim 3,
wherein the first power source supplies the first current for use in normal light emission of the self-luminous display panel, and
wherein the second power source supplies the second current for use in writing display data on the self-luminous display panel.

5. The control apparatus according to claim 1,
wherein the first threshold is a value of a current supplied when an entire surface of the self-luminous display panel is displayed at highest luminance, and
wherein the second threshold is a value of a current supplied when the entire surface of the self-luminous display panel is displayed at lowest luminance.

6. The control apparatus according to claim 1, wherein, upon receiving an instruction to turn on or off the self-luminous display panel, the abnormality detection unit performs abnormality detection on the self-luminous display panel using the second current with the self-luminous display panel displayed at the lowest luminance.

7. The control apparatus according to claim 1, further comprising a notification unit configured, when an abnormality is detected by the abnormality detection unit, reports that the abnormality is detected.

8. A method for controlling display of a self-luminous display panel, the method comprising:
selectively supplying a first current and a second current smaller than the first current to the self-luminous display panel; and
determining, when the second current is supplied, that the display of the self-luminous display panel is abnormal when the second current is larger than a second threshold smaller than a first threshold used as a threshold of the first current.

9. A display apparatus comprising:
a self-luminous display panel; and
a control apparatus configured to control display of the self-luminous display panel,
wherein the control apparatus is the control apparatus according to claim 1.
